(19) United States
(12) Patent Application Publication
(10) Pub. No.: US 2021/0004850 A1
(43) Pub. Date: Jan. 7, 2021

(54) ONLINE CO-PROMOTION SYSTEM FOR FRANCHISEE USING EVENT SERVICE FOR PREDICTING LOTTERY WINNING NUMBERS

(71) Applicant: Chang Keun LEE, Gyeonggi-do (KR)

(72) Inventor: Chang Keun LEE, Gyeonggi-do (KR)

(21) Appl. No.: 16/759,806

(22) PCT Filed: Oct. 25, 2018
(86) PCT No.: PCT/KR2018/012720

§ 371 Date: Apr. 28, 2020

(30) Foreign Application Priority Data
Oct. 31, 2017 (KR) 10-2017-0143170

(51) Int. Cl. G06Q 30/02; G06Q 20/02; G06Q 50/34; G06Q 20/32; G06Q 20/06; G06Q 20/34; G06Q 20/36; G06Q 40/02; G06Q 20/12; G06Q 40/00; G06Q 20/20; G07F 17/32

(52) U.S. Cl. CPC G06Q 30/0212; G07F 17/329; G06Q 50/34; G06Q 20/326; G06Q 20/0655; G06Q 20/341; G06Q 20/367; G06Q 40/025; G06Q 30/0236; G06Q 30/0215; G06Q 30/0213; G06Q 20/127; G06Q 30/0267; G06Q 40/10; G06Q 30/0261; G06Q 20/3224; G06Q 30/0238; G06Q 20/202; G06Q 20/208; G06Q 20/02

(57) ABSTRACT

A franchisee online co-promotion system according to an embodiment of the present invention uses a winning lottery number prediction event service. When purchasing a product, at the time of payment for the purchase made through a credit card, online payment, an online lottery event service app is automatically pushed to a customer's smart terminal to induce automatic entry into a lottery event, and an advertisement service is automatically provided for a franchisee that is an individual seller. A purchaser of the product may expect additional prize money and a prize according to the entry into the online lottery event, and individual franchisees participating in the present system only pay a portion of prize money to be earned and offer the customer an opportunity to earn a large amount of prize money accumulated by all participating franchisees, thereby providing customer satisfaction that is differentiated from that of non-participating franchisees.

### TECHNICAL FIELD

The present invention relates to a franchisee online co-promotion system using a winning lottery number prediction event, and more specifically, to a franchisee online co-promotion system using a new concept winning lottery number prediction event which enables every interested party such as a customer, a seller, a payment agency, and an operator to obtain their mutual benefits by causing a winning lottery number prediction event service app to be pushed to a customer's smart terminal so as to induce entry into a winning lottery number prediction event and cause an advertisement of a franchisee that is an individual seller to be automatically provided in an entry process to enable a purchaser of a product to expect additional prize money and a free gift according to the entry into the online winning lottery number prediction event, by causing individual franchisees participating in the system to only pay a part of prize money to be earned while offering a customer an opportunity to earn a large amount of prize money accumulated by all participating franchisees, and by providing customer satisfaction that is differentiated from that of non-participating franchisees so as to increase a customer attraction effect and significantly promote a sales rate, when purchasing is performed through a credit card, a check card, an online payment using a PG company, or simple payment using KAKAOPAY, NAVER PAY, bitcoin, an electronic wallet, or the like which is used in a product purchasing process at a store such as an offline restaurant or coffee shop or at an online shopping mall or the like.

### BACKGROUND ART

Recently, popularization of the smart phone invigorates marketing using various applications (hereinafter, referred to as ‘apps’).

Numerous apps are developed in various fields of shopping, games, or the like in addition to information retrieval, and smart phone users download and use a free or paid app.

In such a trend, multiple businesses, famous brand manufacturers, large credit card franchisees, online/offline shopping malls, or the like recently use various apps as a channel to prospect for a potential customer thereof and promote sales.

The sales are promoted with various types of marketing promotion being developed in a method of directly supplying an app or entering an app similar to that supplied by ‘AMAZON’ in USA, ‘Alibaba’ in China, or the like and ‘COUPANG’, ‘GMARKET’, or the like in South Korea.

However, the method can be selected by a famous online/offline company having capital strength and a brand, and a problem arises in that the method has many realistic limitations for small business owners.

It is difficult for an owner of a small bakery to afford costs for planning, producing, and distributing an app and further confront significant economic limitations on developing of promotion using the app.

In particular, since it is difficult for a small store or the like such as a bakery to individually and periodically hold a promotion event that offers an expensive free gift, it is difficult to increase the customer attraction effect.

Currently, multiple small franchisees use a promotion method of offering mileage or discount of a certain percentage, a point benefit, or the like to a purchase customer through a partnership with a specific credit card company; however, the method has a limitation in that the offering does not significantly stimulate a customer's expectations.

On the one hand, the number of average daily payments by credit cards used as an online/offline payment means in the South Korean market reached 31,290,000 in the first half of 2017, and the number of average daily payments by check cards increased to 19,370,000. However, as credit card fees are adjusted to gradually decrease, it is true that a profit structure of a credit card company or a VAN company which is a partner company deteriorates.

Hence, it is true that there is a demand for a revolutionary event service system that enables a purchaser to expect prize money and a free gift according to entry into an event whenever card payment is made for product purchase and consumption, that can maximize advertisement effects and customer attraction effects by using a co-promotion system that can offer an expensive free gift at low costs paid by a seller, and that enables a credit card company or a VAN company to obtain additional sales profits.

### SUMMARY OF INVENTION

### Technical Problem

The present invention is made with consideration for such problems described above, and an object of the present invention is to provide a franchisee online co-promotion system using a new concept winning lottery number prediction event which enables every interested party such as a customer, a seller, a payment agency (including a card company, a VAN company, or a PG company), and an operator to obtain their mutual benefits by causing a franchisee online co-promotion application using a winning lottery number prediction event to be automatically pushed to a customer's smart terminal so as to induce automatic entry into the winning lottery number prediction event and cause an advertisement service of a franchisee that is an individual seller to be automatically provided in an entry process by the customer, by enabling a purchaser of a product to expect additional prize money and a free gift according to the entry into the online winning lottery number prediction event, and by maximizing advertisement effects and customer attraction effects for a franchisee so as to promote a sales rate, when the product is purchased through a credit card, a check card, an online payment using a PG company, a simple payment such as KAKAOPAY or NAVER PAY, or a purchase payment using a payment means such as bitcoin or an electronic wallet.

Another object of the present invention is to provide a franchisee online co-promotion system using a winning lottery number prediction event which enables a customer to expect satisfaction from purchase of goods and service and additional profit by increasing an expected value of event participants by a method of dividing entry sections depending on a card payment amount at the time of product purchase, dividing and accumulating prize money of the winning lottery number prediction event for each entry section, and offering prize money of a corresponding section to a winner or offering an additional entry opportunity depending on a section of a transaction amount or the like.

Still another object of the present invention is to provide a franchisee online co-promotion system using a winning lottery number prediction event which increases advertisement effects of franchisees, induces revisiting, and obtains effects of enhancing customer loyalty by providing a separate promotion system for each individual franchisee, in which prize money for the first place is set as accumulated prize money, and for the second to sixth places, application of an additional discount rate and provision of a prize such as a free gift (for example, the sixth place: a bottle of beer, the fifth place: 5% discount, the fourth place: a bottle of wine, the third place: 100 dollars by cash, and the second place: a bottle of whiskey) which are set to be offered for each place by the individual franchisees.

Still another object of the present invention is to provide a franchisee online co-promotion system using a winning lottery number prediction event which is effective to attract potential customers to a franchisee by extracting customers' smart terminals positioned within a certain radius by using a location based service or terminals to which a winning lottery number prediction event app is downloaded, by offering an entry opportunity for the winning lottery number prediction in a pushed form, in which a payment process is omitted, to the extracted terminals at the franchisee's expense, and by exposing an advertisement or a message of the franchisee in an entry process.

Still another object of the present invention is to provide a franchisee online co-promotion system using a winning lottery number prediction event which is effective to attract potential customers by offering an event entry opportunity, in which a card payment process is omitted, in a push form at the franchisee's expense to terminals of target customer classes selected by individual franchisees by using database of member classification (age-specific, district-specific, gender-specific, etc.) of an operator or terminals to which a winning lottery number prediction event app is downloaded, and by exposing an advertisement or a message of the franchisee in an entry process.

### Solution to Problem

According to the present invention to achieve the objects, there is provided a franchisee online co-promotion system using a winning lottery number prediction event service, including: a franchisee server that allows sales approval to be applied online depending on online or offline product purchase of a customer; a payment approving server for approving sales and approving product payment depending on the product purchase of the customer; a winning lottery number prediction event service operating server that operates and provides a service of online winning lottery number prediction event entry to a customer's smart terminal depending on the approving of product payment by the payment approving server; and the customer's smart terminal to which download of an online winning lottery number prediction event service app to be provided to the winning lottery number prediction event service operating server is downloaded, and which allows a customer to participate in the online winning lottery number prediction event entry and select a winning lottery prediction number whenever product purchase is made. The winning lottery number prediction event service operating server checks a winning lottery number every week, notifies a winner's smart terminal of a winning fact online in real time, and pays prize money.

Here, preferably, a means of the product payment is any one of a credit card, a check card, online payment using a PG company, KAKAOPAY, NAVER PAY, bitcoin, and an electronic wallet.

In addition, preferably, the payment approving server includes: a credit card company server for approving credit card sales depending on product purchase; and a VAN company server that confirms credit card payment from a customer depending on product purchase of the customer, receives approval of credit card sales from the credit card company server, and transmits credit card sales payment details to a franchisee server of a credit card.

In addition, preferably, the franchisee server causes a host computer to be connected using a POS terminal in a franchisee so as to input purchase information when a barcode-attached product is purchased, then, reflects the purchase information to purchase and production of the product, and applies the purchase information to purchase management.

In addition, preferably, the VAN company server has database in which information of corresponding customers who signed up for the credit card company server is stored, and the information of the corresponding customers stored in the database is secured in the winning lottery number prediction event service operating server in advance when payment is made through corresponding cards of the customers.

In addition, preferably, the winning lottery number prediction event service operating server includes: a franchisee operating unit that shares a corresponding customer's smart terminal information depending on payment for product purchase at a corresponding franchisee and operates (manages) multiple franchisees; an app providing unit that pushes the online winning lottery number prediction event service app based on information of a corresponding customer which is secured at a time of product purchase or in advance such that the winning lottery number prediction event service app is provided to be downloaded to the customer's smart terminal; a membership operating unit that causes a membership operation to achieve customer membership joining when the online winning lottery number prediction event service app is downloaded to the customer's smart terminal; and a winning lottery number prediction event service operating unit that requests entry into an online winning lottery number prediction event through the online winning lottery number prediction event service app whenever the corresponding customer purchases a product and that checks a lottery number selected by the customer and causes a winning fact to be notified.

In addition, preferably, the franchisee operating unit determines a resource securing method for securing resources of prize money and a prize money distributing method.

In addition, preferably, the franchisee operating unit selects any one between a fixed fee membership under which, in accordance with a contract with the franchisee server, a corresponding franchisee server pays a certain amount of money as accumulated money for lottery prize money every month regardless of the number of times of entry by customers or accumulates a certain amount of money that is set to be paid for each entry by the customers and a fixed percentage membership under which the franchisee server pays a certain percentage of money for each payment of a corresponding customer.

In addition, preferably, under the fixed fee membership, a part of accumulated money for each of the franchisees is accumulated at a fixed percentage as resources for prize money and donation money, and the rest of the accumulated money is distributed as profits for the payment approving server and the winning lottery number prediction event service operating server. Preferably, under the fixed percentage membership, a part of accumulated money is accumulated as resources for prize money and donation money, the accumulated money being obtained through automatic transfer of a portion of payment from the franchisee whenever payment is made by a customer, and the rest of the accumulated money is distributed as profits for the payment approving server and the winning lottery number prediction event service operating server.

Preferably, the winning lottery number prediction event service operating unit includes: a winning lottery number prediction event entry participation requesting unit that requests participation in online winning lottery number prediction event entry by a corresponding app which is downloaded through the membership operating unit whenever a corresponding customer purchases a product; a lottery event selecting unit that allows a corresponding customer to predict a winning lottery number at a time of participation in winning lottery number prediction event entry; a winning fact confirming unit that confirms a winning fact by checking a lottery number selected by a customer and checking an actually drawn lottery number; a winning fact notifying unit that notifies a winner's smart terminal of the winning fact online; and a prize money paying unit that pays corresponding prize money to the winner.

In addition, preferably, the lottery event selecting unit allows a corresponding customer to select a lottery number through a winning lottery number prediction event number selecting screen or to automatically select a lottery number by shaking a customer's smart terminal, causes a text or voice of “entry is applied” to be output through the customer's smart terminal, and causes the selected lottery number to be automatically stored in entry details of a customer's app and database of the winning lottery number prediction event service operating server.

In addition, in the franchisee online co-promotion system using a winning lottery number prediction event service, preferably, the lottery event selecting unit determines data as a result of normal entry, the data being obtained after a message or an advertisement video of a corresponding franchisee or a movie trailer is exposed through a display screen of a customer's smart terminal when a customer selects a lottery number, and displays a predicted number for each lottery drawing broadcast No., time, a corresponding franchisee, a corresponding country of lottery as details of entry made by the customer when the customer touches a menu of entry details after completion of winning lottery number prediction entry.

In addition, preferably, the winning fact confirming unit checks a lottery number selected by a customer and automatically or manually confirms a winning fact from a broadcasting program for actually drawing a lottery number or confirms winning by checking a winning fact from a broadcasting program for drawing a lottery number of each country and a lottery number of a corresponding country selected by a customer.

In addition, preferably, when the winning fact confirming unit confirms no winner, corresponding prize money is carried over and accumulated to the next prize money.

In addition, preferably, the winning fact notifying unit automatically transmits a winning result not only to the customer's smart terminal but also to database of the winning lottery number prediction event service operating server, the VAN company server of the payment approving server, and the franchisee server and notifies information of prize money to be offered and public charge and tax and information of a certain percentage of donation from the prize money along with the winning result.

In addition, preferably, the winning lottery number prediction event service operating unit further includes an entry error handling unit that handles an error occurring in a winning lottery number prediction event entry process, and the entry error handling unit handles an entry error due to an incoming call during an entry process through an app by a customer, incomplete exposure of an advertisement with communications disruption, or transmission failure of a message indicating entry completion, configures a temporary storage unit in the app so as to handle the entry error, and re-performs the entry process by touching stored entry-failure data when the customer opens the temporary storage unit and opens the stored entry-failure data after the customer handles the error.

In addition, preferably, from the temporary storage unit, a winning lottery number prediction event entry opportunity, in which a card payment process is omitted, is offered to a target customer extracted depending on conditions based on customer data indexes (age-specific/gender-specific/district-specific member) which is provided to the winning lottery number prediction event service operating server by the franchisee server.

In addition, preferably, the winning lottery number prediction event service operating unit divides entry sections depending on a customer payment amount, accumulates and differentiates winning lottery number prediction event prize money for each entry section, and pays accumulated money corresponding to a corresponding entry section at a time of winning or adjusts the number of times of entry depending on a payment amount.

In addition, preferably, the winning lottery number prediction event service operating unit extracts customers' smart terminals positioned within a certain radius by using a location based service and provides an advertisement service or a lottery number entry service to the customers' smart terminals within the corresponding radius from a corresponding franchisee at the franchisee's expense.

### Advantageous Effects of Invention

According a franchisee online co-promotion system using a winning lottery number prediction event service according to the above-described present invention, remarkable effects of enabling every interested party such as a customer, a seller, a payment agency (including a VAN company or the like), and an operator to obtain their mutual benefits are achieved by causing a winning lottery number prediction event service app to be automatically pushed to a customer's smart terminal so as to induce automatic entry into a winning lottery number prediction event and cause an advertisement service to be automatically provided for a franchisee that is an individual seller, by enabling a purchaser of a product to expect additional accumulated prize money and a free gift according to the entry into the online winning lottery number prediction event, by allowing individual franchisees participating in the system to only pay a part of prize money to be earned and to offer the customer an opportunity to earn a large amount of prize money accumulated by all participating franchisees, and by providing customer satisfaction that is differentiated from that of non-participating franchisees so as to significantly promote a sales rate, when the product is purchased through a credit card, a check card, an online payment using a PG company, and a purchase payment using KAKAOPAY, NAVER PAY, bitcoin, an electronic wallet, or the like.

In addition, an advantage of raising expectation of a customer purchaser to expect additional profits in addition to purchase effects of goods and service is obtained by dividing entry sections depending on a card payment amount at the time of product purchase and differentiating lottery prize money depending on the entry sections or adjusting the number of times of entry depending on an amount of transaction money.

In addition, another advantage of providing an additional promotion effect of a franchisee itself is obtained by paying accumulated prize money only as prize money for the first place and additionally offering a prize (for example, application of an additional discount percentage or a free gift such as a box of soju (Korean distilled spirits)) depending on an order of second to sixth places at each of the franchisees.

In addition, still another advantage of attracting a customer is obtained by extracting customers' smart terminals positioned within a corresponding radius by using a location-based service, providing a lottery number entry service, in which a card payment process is omitted, to the customers' smart terminals within the certain radius from a corresponding franchisee at the franchisee's expense, and exposing an advertisement of the franchisee in an entry process.

In addition, still another advantage of attracting a customer is obtained by providing a winning lottery number prediction event entry process, in which a payment process is omitted, depending on conditions (for example, 300 women in their thirties) selected by a franchisee, based on customer data indexes (age-specific/gender-specific/district-specific member) of the winning lottery number prediction event service operating server, and by exposing an advertisement of the franchisee in an entry process.

### BRIEF DESCRIPTION OF THE DRAWINGS

FIG. 1 is a schematic configurational diagram of a franchisee online co-promotion system using a winning lottery number prediction event service according to an embodiment of the present invention.

FIG. 2 is a configurational diagram of a payment approving server of the franchisee online co-promotion system using a winning lottery number prediction event service according to the embodiment of the present invention.

FIG. 3 is a configurational diagram of an operation server of the franchisee online co-promotion system using a winning lottery number prediction event service according to the embodiment of the present invention.

FIG. 4 is an entire configurational diagram of the franchisee online co-promotion system using a winning lottery number prediction event service according to the embodiment of the present invention.

FIG. 5 is a flowchart illustrating a method for providing the franchisee online co-promotion system using a winning lottery number prediction event service according to the embodiment of the present invention.

### DESCRIPTION OF EMBODIMENTS

Hereinafter, in order to provide detailed description to the extent that a person with ordinary knowledge in the art to which the invention belongs can easily embody the present invention, a preferred embodiment of the present invention is described in detail with reference to accompanying drawings.

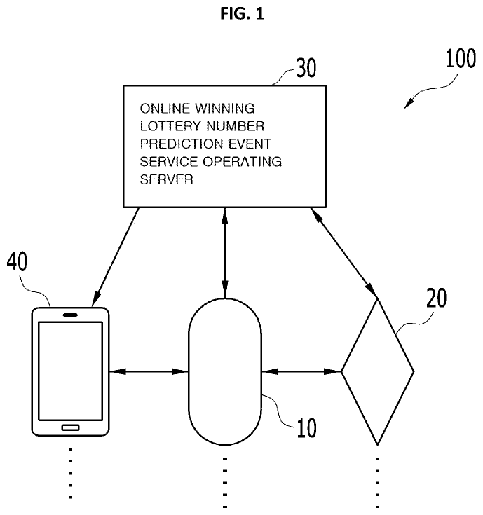

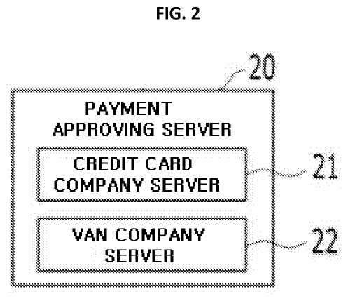

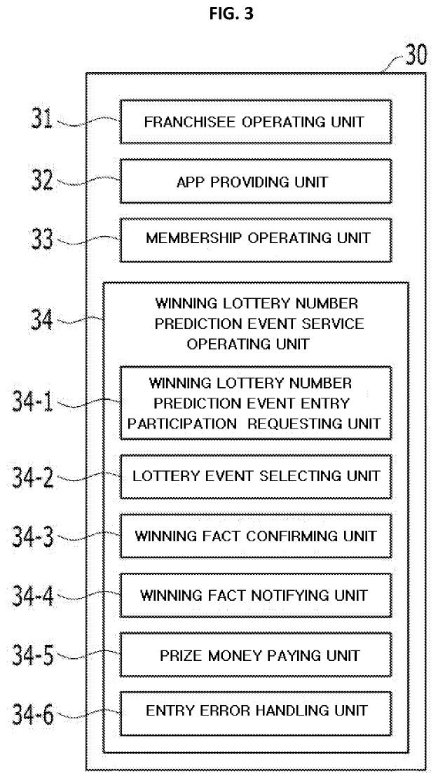

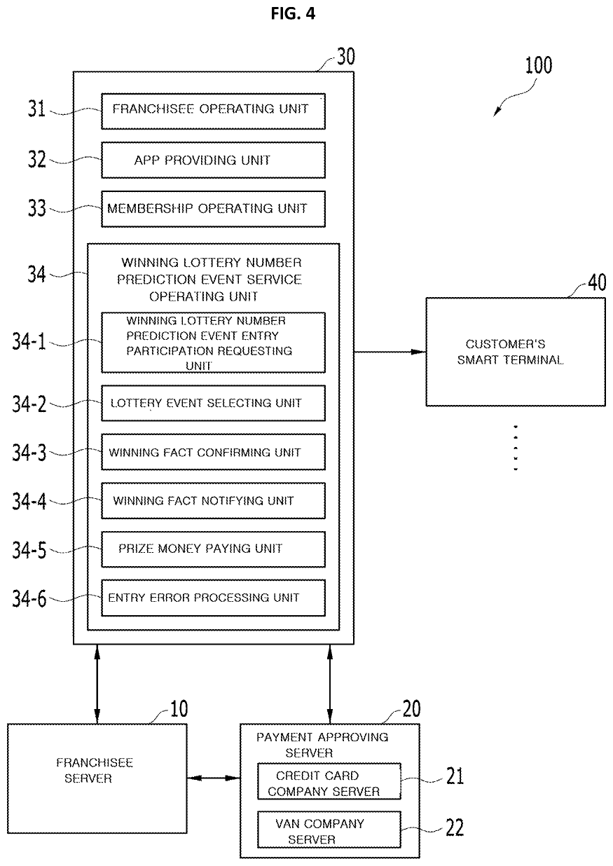

FIG. 1 is a schematic configurational diagram of a franchisee online co-promotion system using a winning lottery number prediction event service according to an embodiment of the present invention. FIG. 2 is a configurational diagram of a payment approving server of the franchisee online co-promotion system using a winning lottery number prediction event service according to the embodiment of the present invention. FIG. 3 is a configurational diagram of a winning lottery number prediction event service operating server of the franchisee online co-promotion system using a winning lottery number prediction event service according to the embodiment of the present invention. FIG. 4 is an entire configurational diagram of a franchisee online co-promotion providing system using a winning lottery number prediction event service according to the embodiment of the present invention.

As illustrated in the drawings, a franchisee online co-promotion system 100 using a winning lottery number prediction event service according to the embodiment of the present invention is configured of a franchisee server 10 that is an individual seller, a payment approving server 20 that causes approval for sales and a product price to be performed online, a winning lottery number prediction event service operating server 30 that operates an online winning lottery number prediction event service, and a customer's smart terminal 40 that is used for signing up for the winning lottery number prediction event service and receiving the service.

Here, the franchisee server 10 is a server of a credit card franchisee at which a credit card terminal is installed to make credit card payment. In this case, as illustrated in FIG. 2, the payment approving server 20 includes a credit card company server 21 for approving credit card sales depending on product purchase and a VAN company server 22 that confirms credit card payment from a customer depending on product purchase of the customer, receives approval of credit card sales from the credit card company server 21, and transmits credit card sales payment details to the franchisee server 10 of a credit card. The credit card is described as an example of payment means in an example illustrated in the drawings; however, it is needless to say that online payment using a PG company, simple payment, or various payment means such as an electronic money can be used, as will be described below.

The franchisee server 10 fulfills a function of allowing sales approval to be applied online depending on offline (store or the like) or online product purchase of a customer.

Here, the franchisee server 10 means a configuration of a website for increasing purchase (sales rate) of a product, for example, a configuration of multiple unspecified individual websites which operate businesses, stores, other various sales branches, and the like.

In the present invention, the franchisee server 10 is provided as a server connected to a credit card terminal to perform a credit card payment depending on product purchase through the credit card company server 21 and the VAN company server 22, and types of businesses and types of categories by handling article of the franchisee server are not limited, as long as the franchisee server has a server configuration for increasing the sales rate.

On the one hand, the franchisee server 10 enables resources for prize money to be secured by accumulating a certain amount of money in a form of advertisement fee, for example, under a fixed fee membership, a fixed percentage membership, or the like to be described below, regarding provision of an online winning lottery number prediction event service in accordance with an additional contract with the winning lottery number prediction event service operating server 30, in addition to a contract for credit card approval through the credit card company server 21 and the VAN company server 22. This is to be described in more specific details at a corresponding part to be provided below.

The payment approving server 20 is a server for approving sales and approving product payment depending on product purchase of a customer and is configured to include a VAN company server 22 as a value added network which has a function of building a network between the franchisee server 10 that is a credit card franchisee and the credit card company server 21 so as to handle a credit card use approval relay and credit card slip purchase work.

Here, in the present invention, a POS system can be used to cause a host computer to be connected using a POS terminal in a franchisee such that purchase information is input when a barcode attached product is purchased, and then the purchase information is reflected to purchase and production of the product and is applied to purchase management.

In other words, the POS system is used at a super supper market such as E-mart, and an approval process with a card company server is executed through the POS system without using a VAN company or a PG company. Hence, the POS system can be replaced with the VAN company server 22, and the same winning lottery number entry opportunity is given even when payment is made through the POS terminal of the POS system.

In addition, the payment approving server 20 includes the credit card company server 21 for approving credit card sales depending on product purchase and the VAN company server 22 that confirms credit card payment from a customer depending on product purchase of the customer, receives approval of credit card sales from the credit card company server 21, and transmits credit card sales payment details to the franchisee server 10 of a credit card.

The VAN company server 22 confirms credit card payment from a customer depending on product purchase of the customer, receives approval of credit card sales from the credit card company server 21, and transmits credit card sales payment details to the franchisee server 10 of the credit card.

Here, the VAN company server 22 stores information of corresponding customers who sign up for various credit card company servers 21 in database (not illustrated), and the information of the corresponding customers stored in the database of the VAN company server 22 can be secured by the winning lottery number prediction event service operating server 30 in advance, when payment is made through corresponding cards of the customers.

The winning lottery number prediction event service operating server 30 fulfills a function of operating and providing a service of online winning lottery number prediction event entry to a customer's smart terminal 40 depending on the approving of product payment of the payment approving server 20.

The winning lottery number prediction event service operating server 30 provides an advertisement service for increasing sales to the franchisee server 10 that is an individual seller and is a configuration of a main website of the present invention which is provided to offer prize money and a free gift to the customer's smart terminal 40 with respect to the online winning lottery number prediction event entry.

The winning lottery number prediction event service operating server 30 is configured of a franchisee operating unit 31, an app providing unit 32, a membership operating unit 33, and a winning lottery number prediction event service operating unit 34.

The franchisee operating unit 31 fulfills a functions of operating (managing) various franchisees and sharing a corresponding customer's smart terminal information depending on credit card payment for product purchase of a corresponding franchisee through a certain contract with the franchisee servers 10 as individual sellers which are joined to be qualified for co-promotion of a winning lottery number prediction event service for increasing sales through the winning lottery number prediction event service operating server 30 that is a main website.

In other words, the franchisee operating unit 31 allows various franchisees (business, store, various sales branch, online shopping mall, and the like) which want to be qualified for co-promotion of the online winning lottery number prediction event service according to the present invention to sign up and provide information of the franchisees as contract members online, and the franchisee operating unit qualifies the franchisees as members and determines a resource securing method for securing resources for prize money and a prize money distributing method.

Here, the franchisee operating unit 31 is configured to select any one between a fixed fee membership under which the corresponding franchisee server 10 pays a certain amount of money (for example, 10 dollars every week four times, total 40 dollars) as accumulated money for lottery prize money every month or a certain amount of money (10 cents for each entry) for each entry, in accordance with a contract with the franchisee server 10, and a fixed percentage membership under which the franchisee server 10 pays a certain percentage (for example, 1% of payment amount) for each payment of a corresponding customer.

A profit distribution in the fixed fee membership is determined by setting a certain distribution ratio, for example, when 40 dollars are accumulated every month for each franchisee. For example, 16 dollars that are 40% can become a resource for prize money accumulated by 4 dollars every week for four weeks in total, 4 dollars that are 10% can be accumulated as donation money for four weeks, and of the rest that are 50%, 10 dollars that are 25% can be paid as sales commission for the payment approving server 20 (VAN company server 22) that secures the franchisees, and 10 dollars that are 25% as the rest can be distributed as a profit for the winning lottery number prediction event service operating server 30.

At that point, since accumulated money for one week paid by one franchisee server 10 is 4 dollars, prize money can be accumulated as follows. Accumulated money gathered from ten thousand franchisees is 40 million dollars every week, accumulated money gathered from one hundred thousand franchisees is 400 million dollars every week, and accumulated money gathered from one million franchisees is 4 billion dollars every week. Assuming that one hundred thousand franchisees participate in the service, prize money accumulated every week is 400 thousand dollars. Hence, although the individual franchisees pay 10 dollars, the individual franchisees can use the total prize money as a powerful promotion means to visiting customers, with a mention of “Thank you for visiting the store. Take an opportunity to get 400 thousand dollars.” In other words, as the number of franchisees participating in the service by paying monthly fixed amount of money increases to one hundred thousand, two hundred thousand, three hundred thousand, or the like, a more effective promotion is achieved in that membership. Preferably, when there is no winner, the accumulated money is carried over and added to accumulated money of the following week.

On the one hand, under the fixed percentage membership, the franchisee server 10 pays a certain percentage (for example, 1%) of every payment transaction as a co-promotion resource. Hence, the payment approving server 20 (VAN company server 22) and the winning lottery number prediction event service operating server 30 receives 1% of payment money to accumulate the money as event prize money, whenever a customer makes card payment through a corresponding franchisee server 10. Hence, when an average payment amount for each payment of customer card members is 40 dollars, 16 cents that are 40% of 40 cents that are 1% of the average payment amount can become a resource for event prize money, 4 cents that are 10% can be accumulated as donation money, 10 cents that are 25% can be paid as sales commission for the payment approving server 20 (VAN company server 22) that secures the franchisees, and 10 cents that are 25% as the rest can be distributed as a profit for the winning lottery number prediction event service operating server 30.

At that point, when the average number of payments per customer card holder is four times every day, and accumulation is performed for seven days, the event prize money of 4.48 dollars obtained by multiplying 16 cents and four times and seven days is accumulated. Hence, in such a structure, an amount of prize money of 44,800 dollars is obtained when there are ten thousand customers, an amount of prize money of 448 thousand dollars is obtained when there are one hundred thousand customers, and an amount of prize money of 4,480 thousand dollars is obtained when there are one million customers.

Assuming that one hundred thousand customers participate in the service every week, the individual franchisees only pay 40 cents per payment; however, an amount of money that can be offered as prize money to a customer reaches 448 thousand dollars. Hence, the participating franchisees notify the customers of the total prize money, thereby developing promotion that is differentiated from that of non-participating franchisees. As the number of customers participating in the winning lottery number prediction event increases to one hundred thousand, two hundred thousand, three hundred thousand, or the like, a more effective promotion is achieved under that membership. When there is no winner, the accumulated money is carried over and added to accumulated money of the following week.

Here, the franchisee operating unit 31 is linked to the franchisee server 10 and can secure a customer's terminal information for the app download of the corresponding customer directly through the franchisee server 10, or the franchisee operating unit can secure the customer's terminal information from the corresponding franchisee server 10 through database of the VAN company server 22 linked with the various credit card company servers 21.

The app providing unit 32 pushes a winning lottery number prediction event service app according to the present invention based on information (phone number or the like of a customer's smart terminal) of the corresponding customer which is obtained at the time of product purchase or in advance such that the winning lottery number prediction event service app can be uploaded to the customer's smart terminal 40.

The membership operating unit 33 allows a customer to sign up for membership (name, address, possessed credit card number, or the like), when the winning lottery number prediction event service app is downloaded to the customer's smart terminal 40.

The winning lottery number prediction event service operating unit 34 includes a winning lottery number prediction event entry participation requesting unit 34-1 that requests participation in online winning lottery number prediction event entry through a corresponding app which is downloaded through the membership operating unit 33 whenever a corresponding customer purchases a product, a lottery event selecting unit 34-2 that allows a corresponding customer to select a predicted winning lottery number at a time of participation in the winning lottery number prediction event entry, a winning fact confirming unit 34-3 that confirms a winning fact by checking a lottery number selected by a customer and comparing the lottery number and an actually drawn lottery number, a winning fact notifying unit 34-4 that notifies a winner's smart terminal of the winning fact online, and a prize money paying unit 34-5 that pays corresponding prize money to the winner.

When the corresponding customer purchases a product through the franchisee server 10, the corresponding app downloaded through the membership operating unit 33 is automatically pushed through the customer's smart terminal 40, and the app is executed by touching the customer's smart terminal 40 of the corresponding customer, the winning lottery number prediction event entry participation requesting unit 34-1 requests the winning lottery number prediction event entry through a touch screen (display of entry menu and prize money) such that the customer participates in the winning lottery number prediction event entry.

When the customer participates in the winning lottery number prediction event entry through the winning lottery number prediction event entry participation requesting unit 34-1, the lottery event selecting unit 34-2 fulfills a function of allowing the corresponding customer to select a predicted winning lottery number.

In other words, a predicted winning lottery number is selected by touching lottery numbers one by one through a winning lottery number prediction event number selecting screen, or a lottery number is automatically selected by shaking a customer's smart terminal. When a customer presses an entry button (after a message or an advertisement of a franchisee is exposed), a text or voice of “entry is applied” is finally output through the customer's smart terminal, and the predicted winning lottery number selected is automatically stored in entry details.

At that point, when the customer selects the predicted winning lottery number, a message or an advertisement (including a video) of the corresponding franchisee or a movie trailer is exposed through a display screen of the customer's smart terminal, and when exposure thereof is allowed, the predicted winning lottery number is confirmed as normal entry data.

At that point, when selection of the predicted winning lottery number is completed as normal entry, and then an entry detail menu is touched, a predicted number of entry for each lottery drawing broadcasting program No., time, a corresponding franchisee, a corresponding country of lottery, and the like are displayed as details of entry made by the customer, entry details for each section according to payment amounts can be checked, and wining results is displayed when winning results are confirmed through the winning fact confirming unit 34-3 to be described below.

Entry into the winning lottery number prediction service is preferably closed (closed at 7 p.m. on every Saturday in South Korea) one hour before lottery draw, and it is needless to say that the time can be set differently for each country.

The winning fact confirming unit 34-3 automatically compares the lottery number predicted by the customer and a number actually drawn at the broadcasting program (at 8 p.m. on every Saturday in Korea) of a broadcasting station, and the winning fact confirming unit pushes and notifies winning result in real time.

In a case of lottery of a foreign country, it is needless to say that the winning fact confirming unit automatically compares a number actually drawn at the broadcasting program of each country and the lottery number predicted by the customer and notifies a winning fact to the customer's app in real time.

Winning result confirmation through the winning fact confirming unit 34-3 can be performed by automatic extraction confirmation, or a result of lottery drawing performed at a broadcasting station is manually input, and then automatic transmission of the winning fact can be performed depending on automatic comparison thereof.

In other words, six numbers drawn at a broadcasting station are automatically or manually input, the stored predicted numbers of the customers are searched and compared. Here, when there are matching numbers, the numbers are automatically extracted, and a winning fact result is confirmed.

At that time, when prize money for the first place is one hundred thousand dollars, and there are two winners, a half of the prize money for first place is paid to each winner, and a third of prize money is distributed to each winner when there are three winners.

When the winning fact confirming unit 34-3 confirms no winner, that is, there is no entry applicant who predicts all of six numbers, preferably, corresponding prize money is carried over and accumulated to the next prize money.

The winning fact notifying unit 34-4 fulfills a function of notifying a winner's smart terminal of a winning fact online.

In other words, notification of the winning fact through the winning fact notifying unit 34-4 is automatically pushed to an app of the winner's (customer's) smart terminal 40 such that a message of “Hong Gil Dong wins the first place of lottery with the predicted winning lottery number provided to entry at a Dunkin' Donuts franchisee and secures event prize money of two hundred thousand dollars.” is displayed on a screen of an entry applicant's app.

It is needless to say that, preferably, the winning fact notifying unit 34-4 automatically transmits a winning result not only to the customer's smart terminal 40 but also to the database of the winning lottery number prediction event service operating server 30, the VAN company server 22 of the payment approving server 20, and the franchisee server 10 such that the winning result of the corresponding customer can be checked.

At that point, the winning fact notifying unit 34-4 sends notification of information of prize money to be offered and public charge and tax, information of a certain percentage of donation from the prize money, and the like along with the winning result.

The prize money paying unit 34-5 fulfills a function of pay the corresponding prize money to a winner.

Here, the prize money paying unit 34-5 pays the prize money basically in accordance with the above-described prize money paying method only to the first place winner who predicts the exact six numbers (1/8.2 million probability); however, prize money for the second to sixth places can be set and paid from accumulated prize money depending on an operation.

At that point, preferably, the prize money paying unit 34-5 compares and authenticates winning information of an application of the winning lottery number prediction event service operating server and basic information input by the customer at the time of signing up for membership and then remits the prize money, and the prize money paying unit uploads the winning result to Hall of Lucky in an app menu such that broadcasting program No. of the lottery number entry/date/franchisee/amount of prize money/receiving ceremony photo (user) is stored and accumulated.

In addition, the winning lottery number prediction event service operating unit 34 further includes an entry error handling unit 34-6 that handles an error occurring in a lottery number entry process.

The entry error handling unit 34-6 handles an entry error due to an incoming call during an entry process through an app by a customer, incomplete exposure of an advertisement with communications disruption, or transmission failure of a message indicating entry completion, or the like, configures a temporary storage unit in the app so as to handle the entry error, and re-performs the entry process by touching stored entry-failure data when the customer opens the temporary storage unit after the customer handles the error.

On the one hand, when target customers are extracted in accordance with conditions based on customer data indexes (age-specific/gender-specific/district-specific member) which is provided to the winning lottery number prediction event service operating server 30 by the franchisee server 10, and an entry opportunity, in which a card payment process is omitted, is offered to the target customer, classification is performed using the entry-failure data in the temporary storage unit, and the entry-failure data in the temporary storage unit is pushed.

For example, target customers are extracted in accordance with data conditions (for example, 100 men in their thirties in Seoul) chosen by a franchisee owner from customer indexes (age-specific/gender-specific/district-specific member) which is provided from the winning lottery number prediction event service operating server 30, a winning lottery number prediction event entry opportunity, in which a card payment process is omitted, is offered through the temporary storage unit of the customers' terminals, and a process of sending a promotional message such as “5% discount in celebration of Happy Hope's first birthday” can be additionally performed in an entry process.

At that time, event costs paid by the franchisee owner can be differentiated for each section selected by the franchisee owner.

In addition, the winning lottery number prediction event service operating unit 34 divides entry sections depending on a credit card payment amount and differentiates lottery prize money depending on the entry sections or adjusts the number of times of entry depending on an amount of transaction money.

In other words, multiple sections are divided to separate entry sections to differentiate lottery prize money by setting the first section to 5 dollars of credit card payment amount, a second section to 50 dollars thereof, a third section to 100 dollars, or the like, for example. Otherwise, the number of times of entry is added and adjusted depending on an amount of money by offering one entry opportunity to 5 dollars, two entry opportunities to 50 dollars, three entry opportunities to 100 dollars, or the like, for example.

For example, assuming that an accumulation percentage is 1%, the winning lottery number prediction event service operating unit 34 accumulates money corresponding to 0.4% (40% of 1%) to an A section for data of a payment smaller than 5 dollars, and a predicted number entry of a customer is stored in entry details of the A section. Similarly, the winning lottery number prediction event service operating unit accumulates money corresponding to 0.4% (40% of 1%) to a B section for a payment amount between 5 dollars and 50 dollars, and a predicted number entry of a customer is stored in entry details of the B section. In addition, the winning lottery number prediction event service operating unit accumulates corresponding money to a C section for a payment amount between 50 dollars and 100 dollars and accumulates money corresponding to 0.4% (40% of 1%) to a D section for a payment amount between 100 dollars and 1,000 dollars, and corresponding entry details are stored as entry details of the D section.

At that point, a total amount of prize money of the A to D sections is displayed on an entry main screen, and prize money accumulated for each section can be displayed at the bottom of the screen or can be displayed on an accumulated prize money screen of a corresponding entry section by automatically moving to the accumulated prize money screen whenever a customer makes entry.

At that point, a winning result is extracted through comparison between entry details for each section and actual winning lottery number. When entry details of a customer in the A section matches the actual winning lottery number, the prize money accumulated in the A section is paid to the customer. Similarly, when entry details of a customer in the D section matches the actual winning lottery number, the prize money accumulated in the D section is paid to the customer.

In addition, one winning lottery number prediction event entry opportunity is offered for data of payment smaller than 5 dollars. Similarly, two winning lottery number prediction event entry opportunities are offered for the payment amount of 5 dollars or larger and smaller than 50 dollars, three opportunities are offered for the payment amount of 50 dollars or larger and smaller than 100 dollars, and four winning lottery number prediction event entry opportunities are offered for the payment amount of 100 dollars or larger and smaller than 1,000 dollars.

In addition, the winning lottery number prediction event service operating unit 34 can pay accumulated prize money as the first place prize money and can additionally offer a prize (for example, application of an additional discount percentage or a free gift (for example, a box of soju (Korean distilled spirits))) depending on an order of second to sixth places from each of the franchisees at the franchisees' expense.

In addition, the winning lottery number prediction event service operating unit 34 can provide a service of extracting customers' smart terminals positioned within a certain radius by using a location based service, offering a winning lottery number prediction event entry opportunity at the franchisees' expense, and exposing an advertisement of the corresponding franchisees before and after entry.

It is needless to say that the online winning lottery number prediction event service app is automatically pushed to the customers' smart terminals 40 positioned within the corresponding radius, when the customers' smart terminals are positioned within a radius (for example, 300 m), such that the online winning lottery number prediction event service app is provided to be downloaded to the customers' smart terminals 40, and thus a lottery number entry service can be provided to the customers' smart terminals along with the advertisement of the corresponding franchisees.

At that time, event costs paid by the franchisee owner can be differentiated for each section selected by the franchisee owner.

On the one hand, in an above-described example, an example of the payment of a credit card at the time of product purchase is described; however, it is needless to say that the present invention can also be equally applied to an online payment using the PG company, a simple payment such as KAKAOPAY or NAVER PAY, or a payment using bitcoin, an electronic wallet, or the like, in addition to purchase through a credit card, and can also be applied to a payment linked with a QR code such as Widget.

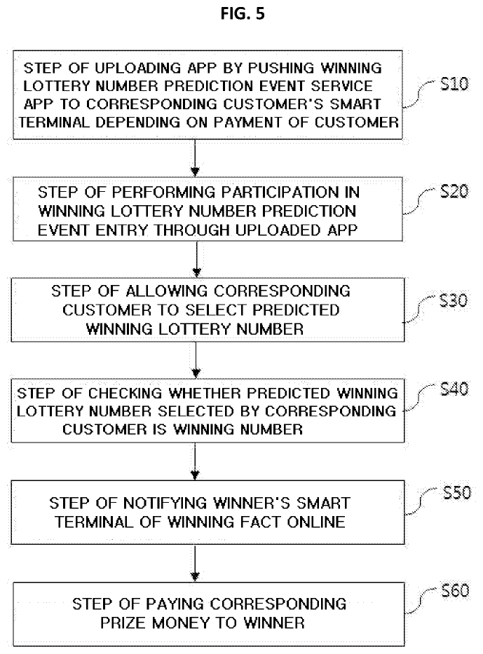

FIG. 5 is a flowchart illustrating a franchisee online co-promotion method using a winning lottery number prediction event service according to the embodiment of the present invention, and the flowchart is described with reference to FIGS. 1 to 4.

As illustrated in FIG. 5, the franchisee online co-promotion method using a winning lottery number prediction event service according to the embodiment of the present invention includes Step S10 of uploading an app by pushing a winning lottery number prediction event service app to a corresponding customer's smart terminal depending on a payment of the customer, Step S20 of performing participation in online winning lottery number prediction event entry through the uploaded app, Step S30 of allowing the corresponding customer to select a predicted winning lottery number, Step S40 of checking whether the predicted winning lottery number selected by the corresponding customer matches an actual winning lottery number, Step S50 of notifying a winner's smart terminal of a winning fact online, and Step S60 of paying corresponding prize money to the winner.

In Step S10 of uploading the app by pushing the online winning lottery number prediction event service app to the corresponding customer's smart terminal depending on the payment of the customer, the app providing unit 32 of the winning lottery number prediction event service operating server 30 pushes the winning lottery number prediction event service app according to the present invention based on information (phone number or the like of the customer's smart terminal) of the corresponding customer which is obtained at the time of product purchase of the customer such that the winning lottery number prediction event service app can be downloaded to be executed in the customer's smart terminal 40.

Here, the information (phone number or the like of the customer's smart terminal) of the corresponding customer is preferably obtained in advance at the time of product purchase of the customer from information stored in the database of the VAN company server 22 joined to the credit card company server 21, but the information of the corresponding customer can be provided by allowing the customer to sign up for membership (name, address, possessed credit card number, or the like), when the winning lottery number prediction event service app is downloaded to the customer's smart terminal 40 according to provision of an app by the app providing unit 32 before the product purchase of the customer.

In Step S20 of performing participation in the online winning lottery number prediction event entry through the uploaded app, when the corresponding customer purchases a product through the franchisee server 10 such that the corresponding app which is downloaded through the membership operating unit 33 is automatically pushed through the customer's smart terminal 40, and the app is uploaded by touching the customer's smart terminal 40 of the corresponding customer, the participation in the winning lottery number prediction event is made through a touch screen (display of entry menu and prize money) such that participation in the winning lottery number prediction event entry is made in the winning lottery number prediction event entry participation requesting unit 34-1.

In Step S30 of allowing the corresponding customer to select a predicted winning lottery number, when the participation in the winning lottery number prediction event entry is made in the lottery event selecting unit 34-2 through the winning lottery number prediction event entry participation requesting unit 34-1, a lottery numbers are selected by touching numbers one by one through a winning lottery number prediction event predicted number selecting screen or lottery numbers are automatically selected by shaking the customer's smart terminal, and a text or voice of “entry is applied” is automatically notified through the customer's smart terminal, when the lottery numbers are selected.

At that point, a message or an advertisement (including a video) of the corresponding franchisee or a movie trailer is exposed through a display screen of the customer's smart terminal when the customer selects the lottery numbers, or entry details (numbers) for each lottery drawing broadcasting program No., time, a corresponding franchisee, a corresponding country of lottery, and the like can be displayed and output, when selection of the predicted winning lottery number is completed, and then an entry detail menu is touched.

In Step S40 of checking whether the lottery number predicted by the corresponding customer is a winning lottery number, the winning fact confirming unit 34-3 checks the lottery numbers predicted by the customer and automatically or manually checks an actually drawn number and confirms a winning fact through actual drawing at the broadcasting program (at 8 p.m. on every Saturday in Korea) of a broadcasting station, and a winning fact result is confirmed by searching and comparing the number stored in entry details of the entry participant.

In a case of lottery of a foreign country, it is needless to say that a number actually drawn at the broadcasting program of each country is automatically or manually recognized and is automatically compared with the lottery number predicted by the customer such that a winning result of the winning lottery number prediction event of the corresponding country is automatically notified.

In Step S50 of notifying the winner's smart terminal of the winning fact online, the winning fact notifying unit 34-4 notifies the customer's smart terminal of the winning fact online in real time, the notification of the winning fact is automatically pushed to an app of the winner's (customer's) smart terminal 40 such that a message of “Hong Gil Dong wins the first place of lottery with the predicted winning lottery number provided to entry at a Dunkin' Donuts franchisee and secures event prize money of two hundred thousand dollars” is displayed on a screen of an entry applicant's app.

It is needless to say that, preferably, the winning fact notifying unit 34-4 automatically transmits a winning result not only to the customer's smart terminal 40 but also the database of the winning lottery number prediction event service operating server 30, the VAN company server 22 of the payment approving server 20, and the franchisee server 10 such that the winning result of the corresponding customer can be checked.

At that point, the winning fact notifying unit 34-4 can send notification of information of prize money to be offered and public charge and tax, information of a certain percentage of donation from the prize money, and the like along with the winning result.

In Step S60 of paying corresponding prize money to the winner, the prize money paying unit 34-5 pays the prize money basically in accordance with the prize money accumulated at the above-described fixed amount or percentage membership only to the first place winner who predicts the exact six numbers (1/8.2 million probability); however, prize money for the corresponding section is paid when entry sections are divided depending on an amount of transaction money.

It is needless to say that the winning lottery number prediction event service operating unit 34 can pay accumulated prize money as the first place prize money and can offer a prize (for example, application of an additional discount percentage, or a free gift (for example, a box of soju (Korean distilled spirits))) depending on an order of second to sixth places from each of the franchisees at the franchisees' expense.

On the one hand, in an above-described example, an example of the payment of a credit card at the time of product purchase is described; however, it is needless to say that the present invention can also be equally applied to an online payment using the PG company, a simple payment such as KAKAOPAY or NAVER PAY, or a payment using bitcoin, an electronic wallet, or the like, in addition to purchase through a credit card or a check card, and can also be applied to a payment linked with a QR code such as Widget.

The present invention can be well understood not to be limited to the embodiment provided in Description of Embodiment. Consequently, an actual technical scope of protection of the present invention is to be determined based on technical ideas of the accompanying claims. In addition, the present invention is understood to include the spirit of the present invention, every modification, equivalent, and replacement within a range of the spirit of the present invention, the spirit being defined by the accompanying claims.

1. A franchisee online co-promotion system using a winning lottery number prediction event service, comprising:
a franchisee server that allows sales approval to be applied online depending on online or offline product purchase of a customer;
a payment approving server for approving sales and approving product payment depending on the product purchase of the customer;
a winning lottery number prediction event service operating server that operates and provides a service of online winning lottery number prediction event entry to a customer's smart terminal depending on the approving of product payment by the payment approving server; and
the customer's smart terminal to which download of an online winning lottery number prediction event service app to be provided to the winning lottery number prediction event service operating server is downloaded, and which allows a customer to participate in the online winning lottery number prediction event entry and select a lottery number whenever product purchase is made,
wherein the winning lottery number prediction event service operating server checks a winning lottery number every week, notifies a winner's smart terminal of a winning fact online in real time, and pays prize money.

2. The franchisee online co-promotion system using a winning lottery number prediction event service according to claim 1, wherein the product payment is any one of a credit card payment, a check card payment, an online payment, a payment with bitcoin, and a payment with electronic wallet.

3. The franchisee online co-promotion system using a winning lottery number prediction event service according to claim 1, wherein the payment approving server includes:
a credit card company server for approving credit card sales depending on product purchase; and a value added network (VAN) server that checks credit card payment from a customer depending on product purchase of the customer, receives approval of credit card sales from the credit card company server, and transmits credit card sales payment details to a franchisee server of a credit card.

4. The franchisee online co-promotion system using a winning lottery number prediction event service according to claim 3, wherein the VAN server has database in which information of corresponding customers who signed up for the credit card company server is stored; and
the information of the corresponding customers stored in the database is secured in the winning lottery number prediction event service operating server in advance, when payment is made through corresponding cards of the customers.

5. The franchisee online co-promotion system using a winning lottery number prediction event service according to claim 1, wherein the winning lottery number prediction event service operating server includes:
a franchisee operating unit that shares a corresponding customer's smart terminal information depending on payment for product purchase at a corresponding franchisee and operates (manages) multiple franchisees;
an app providing unit that pushes the online winning lottery number prediction event service app based on information of a corresponding customer which is secured at a time of product purchase or in advance such that the winning lottery number prediction event service app is provided to be downloaded to the customer's smart terminal;
a membership operating unit that causes a membership operation to achieve customer membership joining when the online winning lottery number prediction event service app is downloaded to the customer's smart terminal; and
a winning lottery number prediction event service operating unit that requests entry into an online winning lottery number prediction event through the online winning lottery number prediction event service app whenever the corresponding customer purchases a product, and that checks a lottery number selected by the customer and causes a winning fact to be notified.

6. The franchisee online co-promotion system using a winning lottery number prediction event service according to claim 5, wherein the franchisee operating unit determines a resource securing method for securing resources of prize money and a prize money distributing method.

7. The franchisee online co-promotion system using a winning lottery number prediction event service according to claim 6, wherein the franchisee operating unit selects any one between a fixed fee membership under which, in accordance with a contract with the franchisee server, a corresponding franchisee server pays a certain amount of money as accumulated money for lottery prize money every month regardless of the number of times of entry by customers or accumulates a certain amount of money that is set to be paid for each entry by the customers and a fixed percentage membership under which the franchisee server pays a certain amount of money for each payment of a corresponding customer.

8. The franchisee online co-promotion system using a winning lottery number prediction event service according to claim 7, wherein, under the fixed fee membership, a part of accumulated money for each of the franchisees is accumulated at a fixed percentage as resources for prize money and donation money, and the rest of the accumulated money is distributed as profits for the payment approving server and the winning lottery number prediction event service operating server; and
under the fixed percentage membership, a part of accumulated money is accumulated as resources for prize money and donation money, the accumulated money being obtained through automatic transfer of a portion of payment from the franchisee whenever payment is made by a customer, and the rest of the accumulated money is distributed as profits for the payment approving server and the winning lottery number prediction event service operating server.

9. The franchisee online co-promotion system using a winning lottery number prediction event service according to claim 5, wherein the winning lottery number prediction event service operating unit includes:
a winning lottery number prediction event entry participation requesting unit that requests participation in online winning lottery number prediction event entry by a corresponding app which is downloaded through the membership operating unit whenever a corresponding customer purchases a product;
a lottery event selecting unit that allows a corresponding customer to predict a winning lottery number at a time of participation in winning lottery number prediction event entry;
a winning fact confirming unit that confirms a winning fact by checking a lottery number selected by a customer and checking an actually drawn lottery number;
a winning fact notifying unit that notifies a winner's smart terminal of the winning fact online; and
a prize money paying unit that pays corresponding prize money to the winner.

10. The franchisee online co-promotion system using a winning lottery number prediction event service according to claim 9, wherein the lottery event selecting unit allows the corresponding customer to select a predicted winning lottery number by touching numbers one by one through a winning lottery number prediction event number selecting screen or to automatically select a lottery number by shaking a customer's smart terminal, causes a text or voice of “entry is applied” to be output through the customer's smart terminal, and causes the selected lottery number to be automatically stored in entry details of a customer's app and database of the winning lottery number prediction event service operating server.

11. The franchisee online co-promotion system using a winning lottery number prediction event service according to claim 9, wherein the lottery event selecting unit determines data as a result of normal entry, the data being obtained after a message or an advertisement video of a corresponding franchisee or a movie trailer is exposed through a display screen of a customer's smart terminal when a customer selects a lottery number, and displays a predicted number for each lottery drawing broadcasting program No., time, a corresponding franchisee, a corresponding country of lottery as details of entry made by the customer when the customer touches a menu of entry details after completion of winning lottery number prediction entry.

12. The franchisee online co-promotion system using a winning lottery number prediction event service according to claim 9, wherein the winning fact confirming unit checks a lottery number selected by a customer and automatically confirms a winning fact from a broadcasting program for actually drawing a lottery number or confirms winning by automatically checking a winning fact from a broadcasting program for drawing a lottery number of each country and a lottery number of a corresponding country selected by a customer.

13. The franchisee online co-promotion system using a winning lottery number prediction event service according to claim 9, wherein, when the winning fact confirming unit confirms no winner, corresponding prize money is carried over and accumulated to the next prize money.

14. The franchisee online co-promotion system using a winning lottery number prediction event service according to claim 9, wherein the winning fact notifying unit automatically transmits a winning result not only to the customer's smart terminal but also database of the winning lottery number prediction event service operating server, the VAN server of the payment approving server, and the franchisee server and notifies information of prize money to be offered and public charge and tax and information of a certain percentage of donation from the prize money along with the winning result.

15. The franchisee online co-promotion system using a winning lottery number prediction event service according to claim 9, wherein the winning lottery number prediction event service operating unit further includes an entry error handling unit that handles an error occurring in a lottery number entry process; and
the entry error handling unit handles an entry error due to an incoming call during an entry process through an app by a customer, incomplete exposure of an advertisement with communications disruption, or transmission failure of a message indicating entry completion, configures a temporary storage unit in the app so as to handle the entry error, and re-performs the entry process by touching stored entry-failure data when the customer opens the temporary storage unit and opens the stored entry-failure data after the customer handles the error.

16. The franchisee online co-promotion system using a winning lottery number prediction event service according to claim 15, wherein, from the temporary storage unit, a winning lottery number prediction event entry opportunity, in which a card payment process is omitted, is offered to a target customer extracted depending on conditions based on customer data indexes (age-specific/gender-specific/district-specific member) which is provided to the winning lottery number prediction event service operating server by the franchisee server.

17. The franchisee online co-promotion system using a winning lottery number prediction event service according to claim 5, wherein the winning lottery number prediction event service operating unit divides entry sections depending on a payment amount, accumulates and differentiates winning lottery number prediction event prize money for each entry section, pays accumulated money corresponding to a corresponding entry section at a time of winning, and adjusts the number of times of entry depending on a payment amount.

18. The franchisee online co-promotion system using a winning lottery number prediction event service according to claim 5, wherein the winning lottery number prediction event service operating unit extracts customers' smart terminals positioned within a certain radius by using a location based service and provides an advertisement service or a lottery number entry service to the customers' smart terminals within the corresponding radius from a corresponding franchisee at the franchisee's expense.

19. The franchisee online co-promotion system using a winning lottery number prediction event service according to claim 1, wherein the franchisee server causes a host computer to be connected using a POS terminal in a franchisee so as to input purchase information when a barcode attached product is purchased, then, reflects the purchase information to purchase and production of the product, and applies the purchase information to purchase management.
